(19) United States
(12) Patent Application Publication
(10) Pub. No.: US 2026/0084569 A1
(43) Pub. Date: Mar. 26, 2026

(54) CHARGER

(71) Applicant: SUBARU CORPORATION, Tokyo (JP)

(72) Inventors: Tomoyuki KITAMURA, Tokyo (JP); Yusuke OTSUKA, Tokyo (JP); Keita NAKAHASHI, Tokyo (JP)

(21) Appl. No.: 19/410,210

(22) Filed: Dec. 5, 2025

Related U.S. Application Data
(63) Continuation of application No. PCT/JP2023/024363, filed on Jun. 30, 2023.

(51) Int. Cl. B60L 53/62; B60L 53/16; B60L 53/18

(52) U.S. Cl. CPC B60L 53/62; B60L 53/16; B60L 53/18

(57) ABSTRACT

A charger that charges a battery for a vehicle includes a cable unit, a plug-locking mechanism, a connector-locking mechanism, a current-voltage controller, a detector, a report controller, and an authenticator. The cable unit includes a charging plug that is plugged into the vehicle, a connector that is coupled to a charger's main body, and a charging cable coupled to the charging plug and the connector. The plug-locking mechanism locks the charging plug. The connector-locking mechanism locks the connector. The current-voltage controller applies test current and voltage to the charging plug. The detector detects abnormality of the charging plug based on a condition of the charging plug when the test current and voltage are applied to the charging plug. The report controller reports whether the abnormality is detected by the detector. The authenticator authenticates a provider of the charger. The connector-locking mechanism unlocks the connector when the provider is authenticated.

### CROSS-REFERENCE TO RELATED APPLICATIONS

This application is continuation of International Application No. PCT/JP2023/024363, filed on June 30, 2023, the entire contents of which are hereby incorporated by reference.

### BACKGROUND

The disclosure relates to a charger and a technology to charge a vehicle such as an electric vehicle.

As is known in the related art, a charger including a locking unit configured to engage with and lock a charging plug has been proposed. In response to successful authentication of a user, the charging plug is unlocked, and charging becomes possible (for example, refer to Japanese Unexamined Patent Application Publication No. 2021-83205).

### SUMMARY

An aspect of the disclosure provides a charger configured to charge a battery for a vehicle. The charger includes a cable unit, a plug-locking mechanism, a connector-locking mechanism, a current-voltage controller, a detector, a report controller, and an authenticator. The cable unit includes a charging plug, a connector, and a charging cable. The charging plug is configured to be plugged into the vehicle. The connector is configured to be coupled to a main body of the charger. The charging cable is coupled to the charging plug on a first end and is coupled to the connector on a second end. The plug-locking mechanism is configured to lock the charging plug. The connector-locking mechanism is configured to lock the connector. The current-voltage controller is configured to apply a test current and a test voltage to the charging plug. The detector is configured to detect abnormality of the charging plug based on a condition of the charging plug when the test current and the test voltage that are applied to the charging plug. The report controller is configured to report whether the abnormality is detected by the detector. The authenticator is configured to authenticate a provider who provides the charger. The connector-locking mechanism is configured to unlock the connector in response to the provider being authenticated by the authenticator.

An aspect of the disclosure provides a charger configured to charge a battery for a vehicle. The charger includes a cable unit, a plug-locking mechanism, a connector-locking mechanism, and circuitry. The cable unit includes a charging plug, a connector, and a charging cable. The charging plug is configured to be plugged into the vehicle. The connector is configured to be coupled to a main body of the charger. The charging cable is coupled to the charging plug on a first end and is coupled to the connector on a second end. The plug-locking mechanism is configured to lock the charging plug. The connector-locking mechanism is configured to lock the connector. The circuitry is configured to apply a test current and a test voltage to the charging plug. The circuitry is configured to detect abnormality of the charging plug based on a condition of the charging plug when the test current and the test voltage that are applied to the charging plug. The circuitry is configured to report whether the abnormality is detected. The circuitry is configured to authenticate a provider who provides the charger. The connector-locking mechanism is configured to unlock the connector in response to the provider being authenticated by the authenticator.

### BRIEF DESCRIPTION OF THE DRAWINGS

FIG. 1 is an explanatory diagram of a system configuration for a charger rental service;

FIG. 2 illustrates an example of a configuration of an information processing apparatus able to be used as a server apparatus, a user terminal, or a provider terminal;

FIG. 3 is a block diagram of a configuration of a vehicle;

FIG. 4 is an explanatory diagram of procedures for the charger rental service;

FIG. 5 illustrates an external appearance of a charger;

FIG. 6 illustrates an internal configuration of the charger;

FIG. 7 is a flowchart illustrating a process of control of abnormality detection and reporting;

FIG. 8 is a flowchart illustrating the process of control of abnormality detection and reporting;

FIG. 9 illustrates a state of each component in the charger;

FIG. 10 illustrates a state of each component in the charger;

FIG. 11 illustrates a state of each component in the charger; and

FIG. 12 illustrates a state of each component in the charger.

### DETAILED DESCRIPTION

A charger may be rented out to many unspecified users. In such a situation, an easily replaceable charging plug is useful since users are not allowed to use the charger if a charging plug malfunctions in the charger.

However, if everybody is allowed to remove the charging plug from the charger, the charging plug may be stolen. It is desirable to provide a charging plug that is easily replaceable by a provider.

### System Configuration

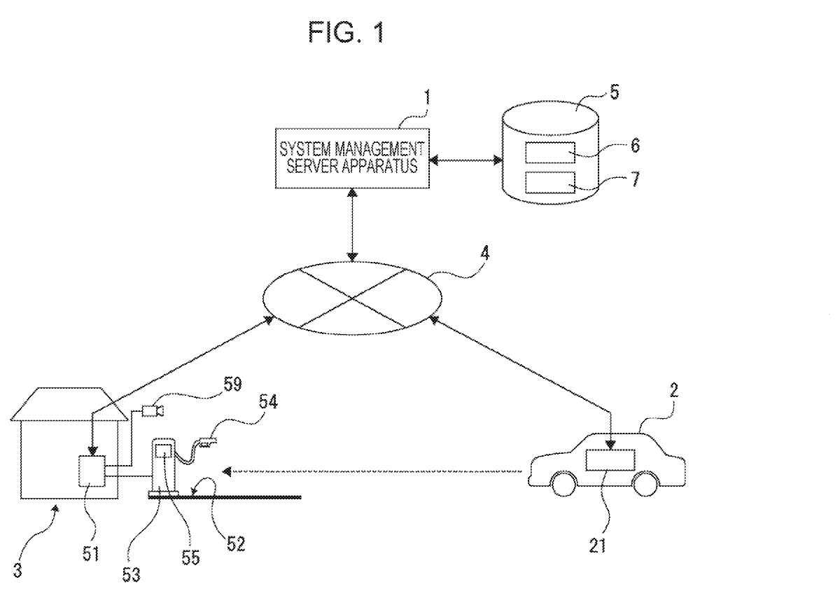

FIG. 1 is a diagram illustrating a system configuration for a charger rental service. The system is able to mediate between a provider of a charger and a user who wants to rent the charger. The system includes a system management server apparatus (server apparatus 1), a user terminal 21, and a provider terminal 51 that are communicatively coupled to each other by a network 4.

A user is a person who registers as a user in the charger rental service provided by the server apparatus 1. A person who wants to use the charger rental service is allowed to start using a charger 53 owned by another person, for example, for a fee by registering as a user.

A provider is a person who uses a parking lot 52 where the charger 53 is installed and who registers as a provider in the charger rental service provided by the server apparatus 1, intending to rent the charger 53 to others. A registered provider is entitled to get paid for allowing others to use the charger 53.

The user terminal 21 is an information processing apparatus to be used by a user and is able to communicate with at least the server apparatus 1 via the network 4. For example, an information processing apparatus in a vehicle 2 may be designated as the user terminal 21, or an information processing apparatus such as a smartphone, a personal computer, or a tablet carried by the user may be designated as the user terminal 21.

The user who uses the user terminal 21 is entitled to the service provided by this system and, for example, uses the user terminal 21 to browse a website provided by the server apparatus 1 or to start an application program.

The provider terminal 51 is an information processing apparatus to be used by a provider and is able to communicate with at least the server apparatus 1 via the network 4. For example, a personal computer located at a place such as the provider's residence 3 or an information processing apparatus built into the charger 53 may be designated as the provider terminal 51. In addition, a device such as a smartphone or a tablet carried by the provider may be designated as the provider terminal 51. Further, an information processing apparatus in a vehicle (not illustrated) used by the provider may be designated as the provider terminal 51.

An information processing apparatus located in the residence 3 or built into the charger 53 and a device such as a smartphone or a tablet carried by the provider may be synchronized with each other and used in combination as the provider terminal 51.

Alternatively, a device such as a smartphone or a tablet carried by the provider may be used as a user interface device configured to provide an interface between the provider and the provider terminal 51 located in the residence 3 or built into the charger 53.

The provider terminal 51 is configured to perform processes such as transmitting availability information to the server apparatus 1 at the provider's convenience and transmitting information regarding a rental operation of the charger 53 to the server apparatus 1. Accordingly, the provider terminal 51 may have any specific design as long as it is an information processing apparatus able to perform such processes. For example, a smartphone and an information processing apparatus in the charger 53 may collaborate to serve as the provider terminal 51.

The server apparatus 1 belongs to, for example, a company that runs the charger rental service and includes one or more information processing apparatuses. The server apparatus 1 is able to access a storage device 5. The storage device 5 is configured to store a provider registration database 6 to register providers and a user registration database 7 to register users.

The server apparatus 1 is configured to communicate with the user terminal 21 and the provider terminal 51 and provide a service for mediating between a user and a provider to provide a charging service at a location and a date and time desired by the user. In this way, the user is able to charge the vehicle 2, for example, even in an area that lacks facilities such as charging stations. The provider gets paid for renting the charger. Thus, a readily available business opportunity is offered to the provider.

The charger 53 is installed in the parking lot 52 in the provider's residence 3. A vehicle owned by the provider is typically parked in the parking lot 52 and is charged with the charger 53. The charger rental service according to an embodiment allows the user to perform charging while the provider uses the vehicle to go out and uses neither the parking lot 52 nor the charger 53.

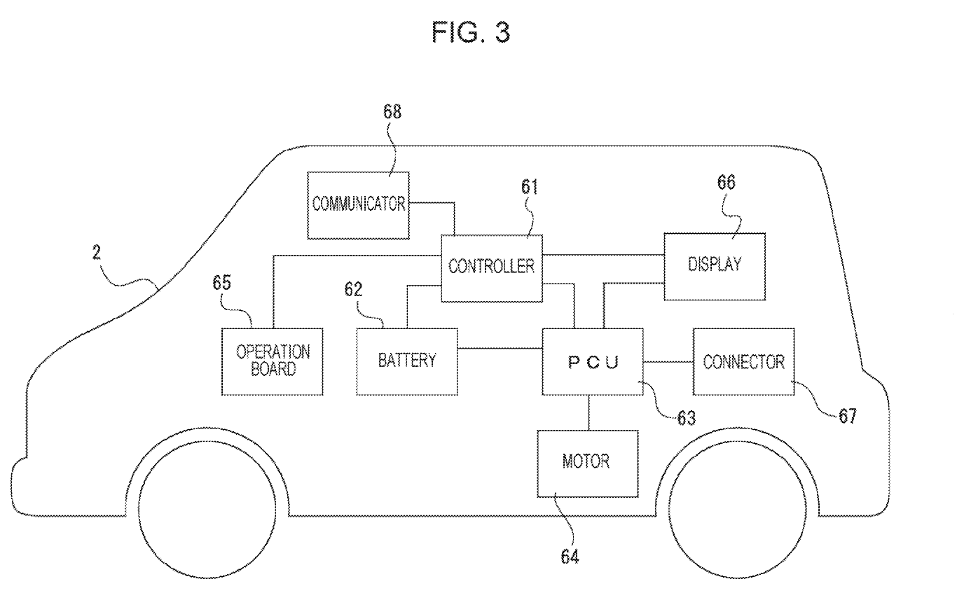

The charger 53 is equipped with a panel 55 as a display and operation panel and, for example, is able to provide the user with instructions for using the charger 53 to perform charging. The user couples a charging plug 54 to a connector 67 (refer to FIG. 3), which is a charging inlet for the vehicle 2, and performs charging.

The charger 53 is equipped with a measuring circuit inside to measure an amount of charge and is configured to measure the amount of charge when performing charging. The provider terminal 51 is able to acquire measurement data regarding the amount of charge measured by the measuring circuit.

In this example, a camera 59 is installed in the parking lot 52. The camera 59 is able to capture images of, for example, the license plate, the body, and the charging operation of the vehicle 2 of the user. The provider terminal 51 is able to acquire information regarding the vehicle 2, such as the license number and the model, from images captured by the camera 59. Alternatively, the provider terminal 51 may transmit image data to the server apparatus 1, and the server apparatus 1 may detect information such as the license number and the model.

While FIG. 1 illustrates the charger 53 assumed to be installed in the parking lot 52 in the residence 3, the residence 3 may be of any type, whether a house or a condominium. The parking lot 52 may be located separated from the residence 3 and may be a parking lot where the provider usually parks a vehicle.

According to the embodiment, the charger 53 to be offered in the charger rental service is installed in the parking lot 52 used by the provider, such as a parking lot on the site of the residence 3, which is the provider's home, or a parking lot located separated from the provider's home but owned or rented by the provider.

The charger 53 is owned or rented by the provider and is usually used by, for example, the provider or the provider's family.

The provider is assumed to be an individual in the above example. An enterprise, such as a company or an organization, may become a provider according to the embodiment, and the parking lot 52 and the charger 53 in FIG. 1 may be a parking lot and a charger belonging to, for example, a company.

### Configuration of Information Processing Apparatus

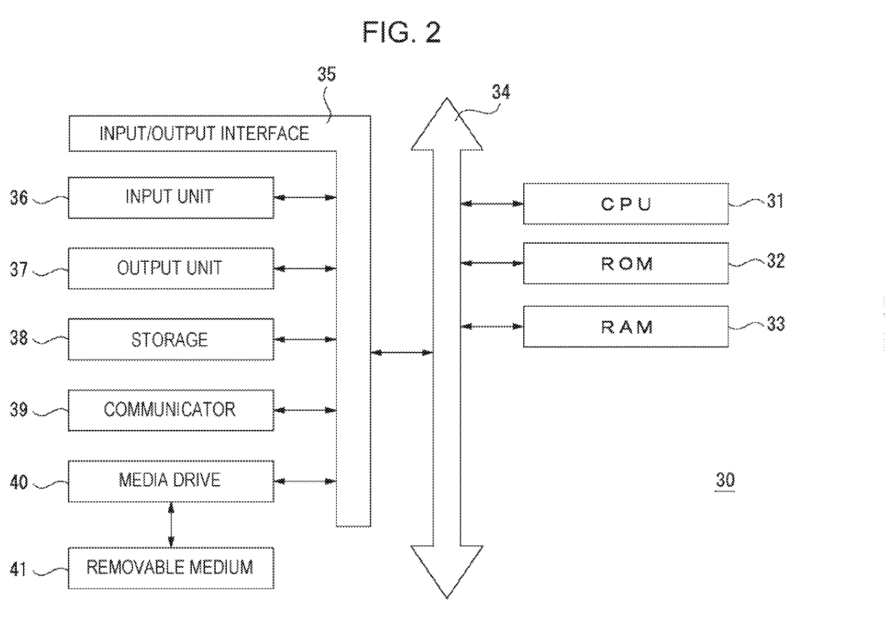

FIG. 2 illustrates an example of a configuration of an information processing apparatus 30 able to be used as the server apparatus 1, the user terminal 21, or the provider terminal 51.

The information processing apparatus 30 includes, for example, a central processing unit (CPU) 31, a read only memory (ROM) 32, a random access memory (RAM) 33, a bus 34, an input/output interface 35, an input unit 36, an output unit 37, a storage 38, a communicator 39, and a media drive 40.

The CPU 31 is configured to perform various processes in accordance with a program stored in the ROM 32 or a program loaded from the storage 38 into the RAM 33. The RAM 33 is also configured to store as appropriate data or the like necessary for the CPU 31 to perform various processes.

The CPU 31, the ROM 32, and the RAM 33 are coupled to each other via the bus 34. The input/output interface 35 is also coupled to the bus 34.

The input/output interface 35 is coupled to the input unit 36, the output unit 37, the storage 38, the communicator 39, and the media drive 40.

The input unit 36 includes, for example, a keyboard, a mouse, a touch panel, and a microphone.

The output unit 37 includes, for example, a display, such as a liquid crystal display (LCD) or an organic electroluminescence (EL) panel, and a loudspeaker.

The storage 38 includes, for example, a hard disk drive (HDD) or a flash memory device. When the information processing apparatus 30 configured in this way serves as the server apparatus 1, the storage 38 may include a database that stores information such as registration data.

The communicator 39 is configured to perform communication processing and communicate with other devices via a communication network.

The media drive 40 is configured to be loaded with a removable medium 41, such as a semiconductor memory card, and data is saved to or retrieved from the removable medium 41.

The information processing apparatus 30 is configured to upload and download data and programs using communication via the communicator 39. Data and programs may be transferred using the removable medium 41.

The CPU 31 configured to perform processing operation based on various programs enables the server apparatus 1, the user terminal 21, or the provider terminal 51 to perform necessary information processing and communication.

### Configuration of Vehicle

A system in a vehicle may be used as the user terminal 21 or the provider terminal 51. FIG. 3 illustrates an example of components to serve as the user terminal 21 or the provider terminal 51 along with components related to charging of the vehicle 2.

The vehicle 2 includes a controller 61, a battery 62, a power control unit (PCU) 63, a motor 64, an operation board 65, a display 66, the connector 67, and a communicator 68.

FIG. 3 illustrates a subset of the components included in the vehicle 2, and the vehicle 2 further includes, for example, a locator map, various sensors for driving, and a communication device, which are not illustrated.

The controller 61 includes, for example, a CPU and a memory and is configured to perform coordinated control of the vehicle 2. The controller 61 may be implemented as a single unit or may include multiple electronic control units (ECUs). Examples of the multiple ECUs may include various types of ECUs, such as a battery control ECU configured to control, for example, charging of the battery 62, a display control ECU configured to perform, for example, display control of display devices (also including devices such as meters) included in the vehicle 2, an airbag control ECU, and an air-conditioner ECU.

According to the embodiment, the vehicle 2 may be an autonomously driven automobile and thus includes an information processing apparatus necessary for autonomous driving. For example, the controller 61 may include ECUs such as an autonomous driving ECU, a running control ECU, and a steering control ECU. The autonomous driving ECU is configured to determine a driving path and perform control based on the surroundings, the running control ECU is configured to control running and stopping by the motor in accordance with instructions from the autonomous driving ECU, and the steering control ECU is configured to control steering in accordance with instructions from the autonomous driving ECU.

To control autonomous driving, the vehicle 2 also includes a device configured to monitor the surroundings, such as a camera or a sensor, and a device configured to detect information such as map data, road data, and a current location, but such devices are not illustrated.

The controller 61 is configured to execute various programs stored, for example, in a memory to achieve various functions.

Thus, the controller 61 may have a configuration equivalent to the configuration in FIG. 2.

The battery 62 is a high-voltage battery to be used to run the vehicle 2. The battery 62 is configured to supply electric power to be used to drive wheels, electric power to be used to operate an air-conditioning device in the vehicle 2, and electric power to be used to operate other devices.

FIG. 3 illustrates electric power supply from the battery 62 to be used to drive wheels and to operate the display 66, and electric power supply to be used to operate other components is not illustrated.

The battery 62 is configured to be charged with a current supplied from the PCU 63.

The battery 62 is configured to provide the PCU 63 with a supply voltage to drive the motor 64.

The PCU 63 includes components such as an inverter and a DC/DC converter to drive the motor 64.

The PCU 63 is configured to, based on the provided supply voltage described above, generate and provide to the motor 64 an alternating current to drive the motor 64. The PCU 63 is configured to control torque of the motor 64 by controlling the alternating current. The PCU 63 may have a regenerative braking function to provide a function to optimize energy efficiency using regenerative energy.

The motor 64 is configured as a motor-generator having a power generating function and is configured to drive wheels based on the provided alternating current.

The operation board 65 includes operation elements such as various buttons or levers disposed in front of the driver's seat in the vehicle 2. The operation board 65 may include display devices such as a multifunction display (MFD) having a touch panel function and a display of a navigation device.

The display 66 collectively represents, for example, an MFD disposed in front of a driver or other display devices to present information to a driver. The display 66 is configured to present information based on a detected signal obtained by various sensors included in the vehicle 2. The display 66 is configured to display as appropriate various kinds of data including the total mileage of the vehicle, the outdoor air temperature, and instantaneous fuel consumption. The display 66 is also able to display, for example, map data and extracted route data.

The display 66 may also be configured to display a screen for the charger rental service according to the embodiment.

The connector 67 includes a structure able to receive a plug for charging (the charging plug 54) included in the charging equipment such as the charger 53. The connector 67 is configured to output to the PCU 63 an alternating-current voltage provided via the plug for charging received by the connector 67. The PCU 63 includes an AC/DC converter and is configured to charge the battery 62 by providing the battery 62 with a direct-current voltage obtained by conversion.

The communicator 68 includes a wireless communication device and is configured to, for example, communicate with the server apparatus 1 via the network 4.

### Outline of Charger Rental Service

Description will be given with regard to a process outline of the charger rental service provided by the server apparatus 1.

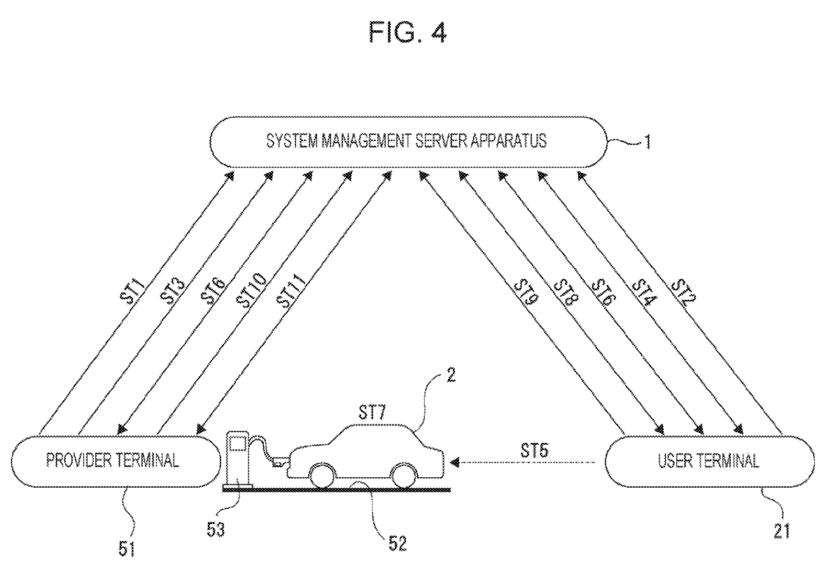

The service is provided in accordance with procedures from ST1 to ST11 illustrated in FIG. 4 including actions by the user and the provider.

ST1: A person who wants to be a provider uses the provider terminal 51 to register in the server apparatus 1 the charger 53 that may be rented. In one example, the person who wants to be a provider registers the personal information of the person, the billing information, the information regarding the location of the parking lot 52, and the model and specification of the charger 53.

ST2: A person who wants to be a user uses the user terminal 21 to register in the server apparatus 1 user information (such as vehicle information and personal information).

ST3: The provider uses the provider terminal 51 at any time to transmit, to the server apparatus 1, availability information including a date and time when the charger 53 is available for rent. The availability information is used to report to the server apparatus 1 that the provider is able to offer the parking lot 52 to the others from a certain date and time to a certain date and time.

ST4: The user uses the user terminal 21 at any time to transmit, to the server apparatus 1, a request for use of the charger 53. The request for use contains, for example, information regarding where and when the user wants to use the charger 53. In response to the request for use from the user, the server apparatus 1 selects, from the providers who have sent availability information, one or more providers who have provided the area and the date and time that match those in the request, and the server apparatus 1 offers the user a list of the chargers 53 available for rent. The user performs an operation on the server apparatus 1 to make a reservation for using the charger 53 of choice. In response to the user operation for the reservation, the server apparatus 1 sets up the reservation.

ST5: The vehicle 2 of the user moves at the reserved date and time to the parking lot 52 where the charger 53 is installed.

ST6: The user is authenticated by the user terminal 21, the provider terminal 51, or the charger 53 when using the charger 53. The result of authentication is also shared by the server apparatus 1.

ST7: Charging is performed. The provider terminal 51 also measures the amount of charge at this time.

ST8: After the charge, the user terminal 21 and the server apparatus 1 settle a bill for the fee.

ST9: The user uses the user terminal 21 (or a device such as a smartphone configured to serve as a user interface device for the user terminal 21) to transmit information regarding the evaluation of the provider.

ST10: The provider uses the provider terminal 51 to transmit the evaluation of the user to the server apparatus 1.

ST11: The server apparatus 1 pays the fee to the provider.

The order of ST8, ST9, ST10, and ST11 may differ from the above. The steps ST1, ST2, ST3, and ST4 are sequentially performed between unspecified people and the server apparatus 1.

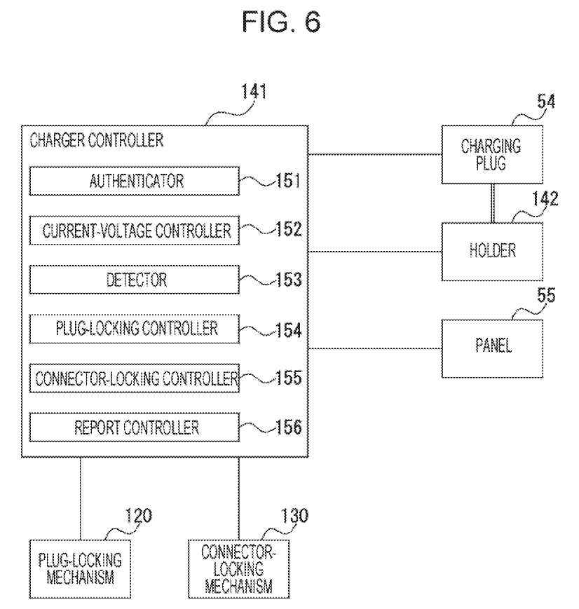

The charger 53 is used by many unspecified users in this way. The charging plug 54 in the charger 53 is plugged into or unplugged from the connector 67 in the vehicle 2 and is plugged into or unplugged from a holder 142 in the charger 53 (refer to FIG. 6) configured to hold the charging plug 54.

Consequently, the charging plug 54 in the charger 53 may be damaged by the user. A user who has damaged the charging plug 54 is to be identified among many unspecified users who use the charger 53.

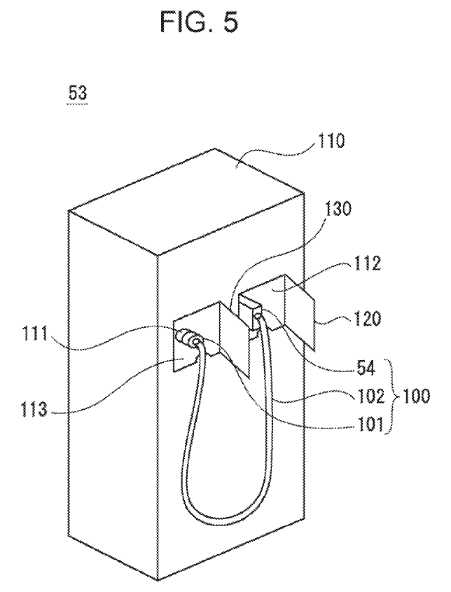

A damage actually occurs somewhere in a cable unit 100 (refer to FIG. 5) including the charging plug 54. Since it is difficult to diagnose a malfunction (abnormality) of the charging plug 54 separately in the cable unit 100, the cable unit 100 being damaged somewhere is referred to simply as the charging plug 54 being damaged. Accordingly, in the embodiment, a cable-side connector 101 or a charging cable 102 being damaged in the cable unit 100 is also referred to as the charging plug 54 being damaged.

When the cable unit 100 is damaged, a situation such as being unable to plug the charging plug 54 into the connector 67 in the vehicle 2 occurs, leading to an inability to charge the battery 62 in the vehicle 2 with the charger 53. If a user who has reserved and is going to use the charger 53 (referred to as a user having a reservation, hereinafter) is not aware of the charger 53 being damaged and recognizes the damage upon arrival at a location where the charger 53 is installed, the user is likely to suffer a disadvantage, for example, because the effort and time to move to the location are wasted and the battery 62 becomes empty, being unable to be charged. Thus, it is also necessary to inform a user having a reservation that the charger 53 has become unavailable.

The charger 53 according to the embodiment is able to detect whether abnormality is present in the cable unit 100 and inform, for example, users, providers, and users having a reservation whether the abnormality is present.

FIG. 5 illustrates an external appearance of the charger 53. The panel 55 is not depicted in FIG. 5. As illustrated in FIG. 5, the charger 53 is equipped with the cable unit 100 able to be attached to or detached from a main body 110. The cable unit 100 includes the cable-side connector 101, the charging cable 102, and the charging plug 54.

The cable-side connector 101 is able to be attached to or detached from a body-side connector 111 disposed on the main body 110. The charging cable 102 is an electric cable having a first end coupled to the charging plug 54 and a second end coupled to the cable-side connector 101.

The main body 110 is equipped with a plug-locking mechanism 120 and a connector-locking mechanism 130.

The plug-locking mechanism 120 is able to lock the charging plug 54. The plug-locking mechanism 120 includes, for example, a plug-locking door able to open or close a compartment 112 in which the charging plug 54 is stored. The charging plug 54 is allowed to be plugged into or unplugged from the main body 110 while the plug-locking mechanism 120 (plug-locking door) is unlocked (open). In contrast, the charging plug 54 is not allowed to be plugged into or unplugged from the main body 110 while the plug-locking mechanism 120 (plug-locking door) is locked (closed).

The plug-locking mechanism 120 may include a different component instead of a component such as a plug-locking door as long as the charging plug 54 is allowed to be locked. For example, the plug-locking mechanism 120 may include a component such as a pin to engage with the charging plug 54 while the charging plug 54 is stored in the main body 110.

The connector-locking mechanism 130 is able to lock the cable-side connector 101. The connector-locking mechanism 130 includes, for example, a connector-locking door able to open or close a compartment 113 in which the cable-side connector 101 coupled to the body-side connector 111 is stored. The cable-side connector 101 is allowed to be plugged into or unplugged from the main body 110 while the connector-locking mechanism 130 (connector-locking door) is unlocked (open). In contrast, the cable-side connector 101 is not allowed to be plugged into or unplugged from the main body 110 while the connector-locking mechanism 130 (connector-locking door) is locked (closed).

The connector-locking mechanism 130 may include a different component instead of a component such as a connector-locking door as long as the cable-side connector 101 is allowed to be locked. For example, the connector-locking mechanism 130 may include a component such as a pin to engage with the cable-side connector 101 while the cable-side connector 101 is stored in the main body 110.

FIG. 6 illustrates an internal configuration of the charger 53. As illustrated in FIG. 6, the charger 53 includes a charger controller 141 and the holder 142 in addition to the cable unit 100 (the charging plug 54, the cable-side connector 101, and the charging cable 102), the plug-locking mechanism 120, the connector-locking mechanism 130, and the panel 55. The main body 110 includes the charger controller 141 and the holder 142.

The charger controller 141 is a computer including a CPU, a ROM, and a RAM. The charger controller 141 may be configured similarly to the information processing apparatus 30 described above. The charger controller 141 may be the provider terminal 51.

The CPU is configured to perform various processes in accordance with programs stored, for example, in the ROM, and thereby the charger controller 141 controls the charger 53 as a whole. The charger controller 141 is configured to serve as an authenticator 151, a current-voltage controller 152, a detector 153, a plug-locking controller 154, a connector-locking controller 155, and a report controller 156.

The holder 142 is disposed inside the compartment 112 (refer to FIG. 5) and is able to hold the charging plug 54. The holder 142 includes electrical terminals each of which is able to be electrically coupled to a corresponding electrical terminal included in the charging plug 54 when the charging plug 54 is plugged into the holder 142. The electrical terminals included in the holder 142 are coupled to the charger controller 141, and the charger controller 141 is able to acquire, for example, a current and a voltage that are input to the electrical terminals.

The authenticator 151 is configured to authenticate a user who uses the charger 53 and a provider who provides the charger 53. The authenticator 151 may be configured to authenticate the user and the provider by receiving the result of authentication performed by the user terminal 21 and the provider terminal 51, respectively, or may be configured to authenticate the user and the provider, for example, by password entry into the panel 55 by the user and the provider, respectively. To perform authentication by password entry into the panel 55, for example, the server apparatus 1 may issue a password or the like to a user in advance when a reservation is made, and the user may be authenticated by entering the password when using the service.

The current-voltage controller 152 is configured to control an alternating-current voltage supplied to the vehicle 2 when the charging plug 54 is coupled to the connector 67 in the vehicle 2. The current-voltage controller 152 is also configured to apply a test current and a test voltage to the charging plug 54 (cable unit 100) while the holder 142 holds the charging plug 54.

While the holder 142 holds the charging plug 54, in response to the test current and the test voltage applied to the charging plug 54 (cable unit 100), the electrical terminals of the holder 142 coupled to the electrical terminals of the charging plug 54 are subjected to a current and a voltage in accordance with the test current and the test voltage if the charging plug 54 is in a normal condition.

The detector 153 is configured to acquire via the electrical terminals of the holder 142 the voltage and the current based on the test current and the test voltage applied to the charging plug 54 while the holder 142 holds the charging plug 54. The detector 153 is configured to then calculate a resistance value of the charging plug 54 (cable unit 100) based on the acquired current and voltage and detect abnormality of the charging plug 54 (cable unit 100) based on the calculated resistance value. The ROM in the charger controller 141 is configured to store the range of the resistance value (normal range) that the charging plug 54 may have in response to the test current and the test voltage when the charging plug 54 is in the normal condition. The detector 153 is configured to determine that the charging plug 54 is in the normal condition when the resistance value of the charging plug 54 is within the normal range and determine that the charging plug 54 is in an abnormal (malfunctioning) condition when the resistance value of the charging plug 54 is out of the normal range.

The plug-locking controller 154 is configured to control locking and unlocking the plug-locking mechanism 120. The connector-locking controller 155 is configured to control locking and unlocking the connector-locking mechanism 130.

The report controller 156 is configured to report whether abnormality of the charging plug 54 is present to the user, the user having a reservation, the provider, and the server apparatus 1.

Whether abnormality of the charging plug 54 is present may be reported to the user terminal 21 and the provider terminal 51. Whether abnormality of the charging plug 54 is present may be displayed by the panel 55. Whether abnormality of the charging plug 54 is present may be reported to the server apparatus 1 and thereafter reported to the user terminal 21 and the provider terminal 51 from the server apparatus 1.

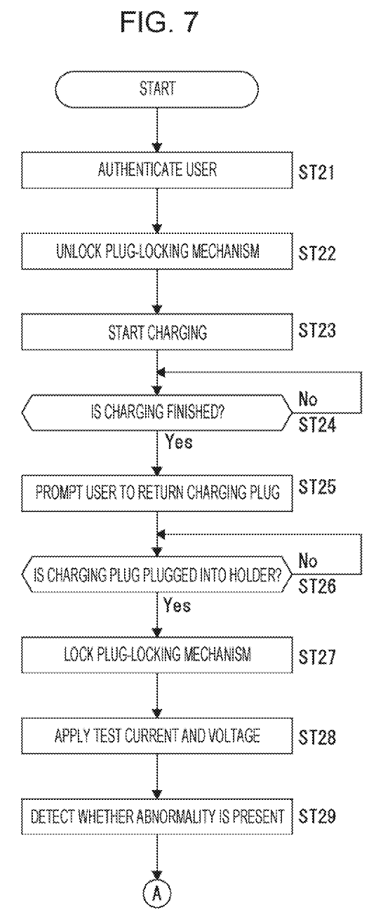

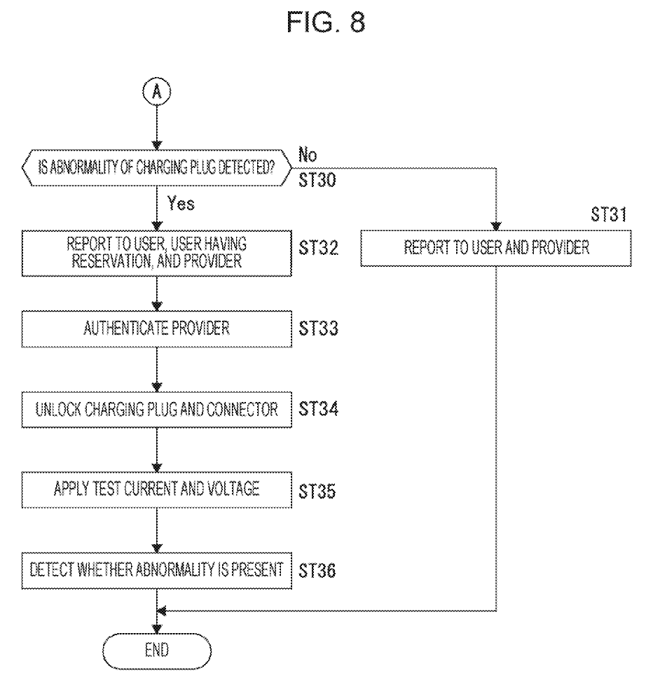

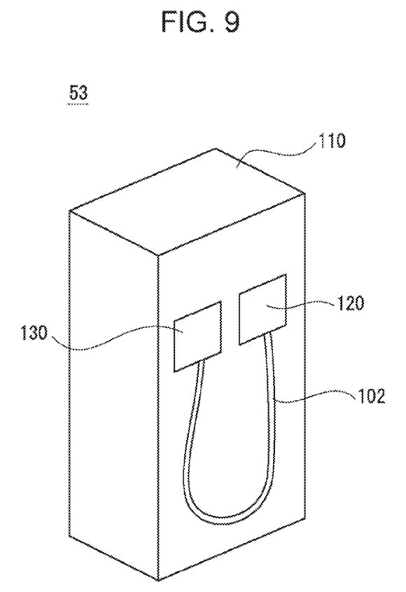

FIG. 7 and FIG. 8 present a flowchart illustrating a process of control of abnormality detection and reporting. FIG. 9 to FIG. 12 each illustrate a state of each component in the charger 53.

Next, description will be given with regard to the control of abnormality detection and reporting in which the charger controller 141 in the charger 53 detects and reports whether abnormality of the charging plug 54 is present.

Before the control of abnormality detection and reporting starts, that is, while the charger 53 does not perform charging, the plug-locking mechanism 120 and the connector-locking mechanism 130 are locked as illustrated in FIG. 9. The plug-locking mechanism 120 is locked, that is, the plug-locking door is closed, and thereby the charging plug 54 is not allowed to be removed. The connector-locking mechanism 130 is locked, that is, the connector-locking door is closed, and thereby the cable-side connector 101 is not allowed to be removed.

As illustrated in FIG. 7, once the control of abnormality detection and reporting starts and the user starts to use the charger 53, first in ST21, the authenticator 151 authenticates the user who is to use the charger 53.

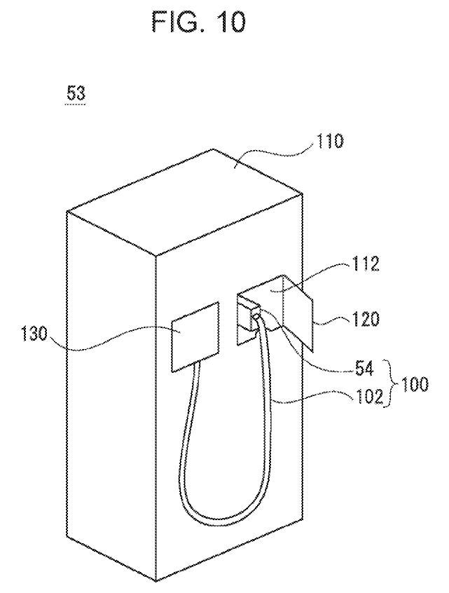

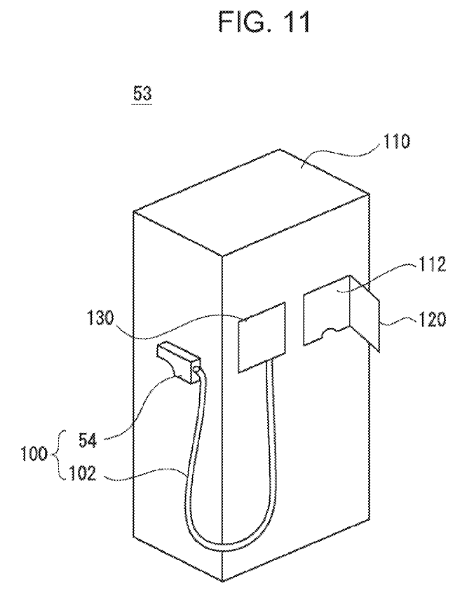

In response to the user being authenticated, the plug-locking controller 154 unlocks the plug-locking mechanism 120 in ST22 as illustrated in FIG. 10. In other words, the plug-locking controller 154 opens the plug-locking door. As illustrated in FIG. 11, this operation allows the user to remove the charging plug 54 from the main body 110. Then, the user plugs the charging plug 54 into the connector 67 in the vehicle 2.

In response to the charging plug 54 being plugged into the connector 67, the current-voltage controller 152 applies an alternating-current voltage via the cable unit 100 and charges the battery 62 in ST23. The current-voltage controller 152 determines in ST24 whether the charging of the battery 62 is finished. It is determined in this case whether the charging is finished, for example, based on the state of charge (SOC) of the battery 62 transmitted from the vehicle 2 via the cable unit 100. The current-voltage controller 152 repeats ST24 to continue charging the battery 62 until the charging of the battery 62 is finished.

In response to the charging being finished (Yes in ST24), the report controller 156 prompts the user to return the charging plug 54 to the original position (plug the charging plug 54 into the holder 142) in ST25. In this situation, for example, a message such as "Return the charging plug to the original position" is displayed by the panel 55 or a voice message is issued for guidance.

The current-voltage controller 152 determines in ST26 whether the charging plug 54 is plugged into the holder 142. For example, the test current and the test voltage may be applied to the cable unit 100, and a current and a voltage at the electrical terminals of the holder 142 may be monitored to determine whether the charging plug 54 is plugged in. The holder 142 may include a contact sensor, and the contact sensor may detect the contact of the charging plug 54 to determine whether the charging plug 54 is plugged in.

After waiting for the charging plug 54 to be plugged into the holder 142 (No in ST26), in response to the charging plug 54 being plugged into the holder 142 (Yes in ST26), the plug-locking controller 154 locks the plug-locking mechanism 120 in ST27. In this way, the user or other people are not allowed to remove the charging plug 54.

Unless the charging plug 54 is returned to the original position, abnormality of the charging plug 54 is not to be diagnosed. Thus, if the charging plug 54 is not returned to the original position for a predetermined duration, the report controller 156 may report to the server apparatus 1 that the charging plug 54 is not returned to the original position and cause the server apparatus 1 to inform a user having a reservation that the charger 53 has become unavailable.

After this operation, no user having a reservation is allowed to use the charger 53, and thus this operation is able to prevent inability to determine who has caused the abnormality of the charging plug 54. Such inability may occur when abnormality of the charging plug 54 is detected after multiple users use the charging plug 54.

If the user does not return the charging plug 54 to the original position, the server apparatus 1 may impose a penalty such as a fine on the user.

Thereafter, the current-voltage controller 152 applies the test current and the test voltage to the cable unit 100 in ST28. In ST29, the detector 153 acquires the current and the voltage of the charging plug 54 via the electrical terminals of the holder 142 and calculates a resistance value of the charging plug 54 based on the acquired voltage and current.

The detector 153 then detects whether abnormality of the charging plug 54 is present based on the calculated resistance value.

As illustrated in FIG. 8, the report controller 156 determines in ST30 whether the abnormality of the charging plug 54 is detected. If the abnormality of the charging plug 54 is not detected (No in ST30), the report controller 156 reports in ST31 to the user and the provider at this time that the abnormality of the charging plug 54 is not detected.

In contrast, if the abnormality of the charging plug 54 is detected (Yes in ST30), the report controller 156 reports in ST32 to the user, the user having a reservation, and the provider at this time that the abnormality of the charging plug 54 is detected.

In this case, since the report controller 156 reports to the user having a reservation that the abnormality of the charging plug 54 is detected and that the charger 53 is unavailable for charging, the user having a reservation does not bother to come to the location where the charger 53 is installed.

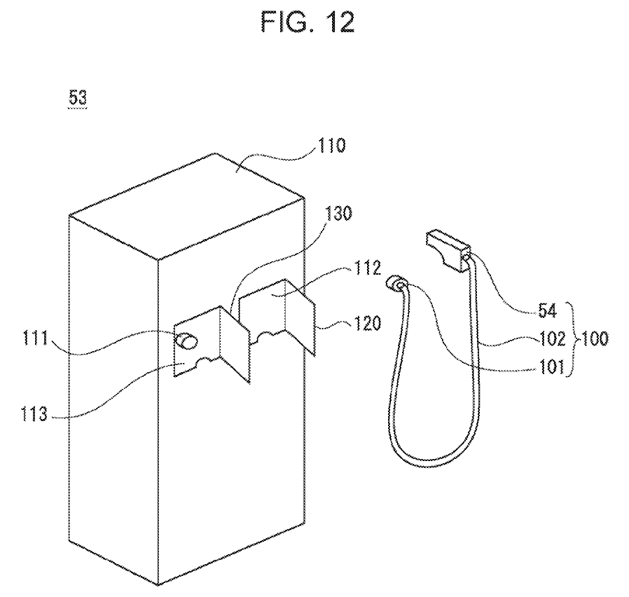

Thereafter in ST33, the authenticator 151 authenticates the provider who comes to replace the charging plug 54 (cable unit 100). In response to the provider being authenticated, in ST34, the plug-locking controller 154 unlocks the plug-locking mechanism 120, and the connector-locking controller 155 unlocks the connector-locking mechanism 130. As illustrated in FIG. 12, this operation allows the provider to remove the cable unit 100 from the main body 110.

After the provider replaces the cable unit 100, the current-voltage controller 152 applies the test current and the test voltage to the cable unit 100 in ST35. In ST36, the detector 153 acquires the current and the voltage of the charging plug 54 via the electrical terminals of the holder 142 and calculates a resistance value of the charging plug 54 based on the acquired voltage and current. The detector 153 then detects whether abnormality of the charging plug 54 is present based on the calculated resistance value. In this way, it is possible to check whether the cable unit 100 has properly been replaced.

The processes in ST35 and ST36 may be omitted.

### Modification

The embodiment according to the disclosure has been described as above, but the embodiment of the disclosure is not limited to the example described above, and various configurations are possible.

For example, in the above embodiment, the current-voltage controller 152 is configured to apply the test current and the test voltage to the charging plug 54 (cable unit 100) in ST28. However, the current-voltage controller 152 may control one of the test current and the test voltage, leading to the test current and the test voltage being applied to the charging plug 54 as a result.

In the above embodiment, the detector 153 is configured to detect abnormality (malfunctioning) based on the resistance value of the charging plug 54. However, the detector 153 may detect abnormality based on the state of the charging plug 54, such as the current and the voltage, presence or absence of electrical conduction, electrostatic capacitance, and inductance of the charging plug 54.

In the above embodiment, the detector 153 is configured to detect abnormality of the charging plug 54 (cable unit 100) based on the resistance value derived from the voltage and the current based on the test current and the test voltage applied to the charging plug 54.

However, if the cable unit 100 includes a communication line configured to establish communication between the vehicle 2 and the charger 53 when the charging plug 54 is coupled, the detector 153 may detect abnormality of the charging plug 54 (cable unit 100) based on a condition of communication with the vehicle 2 using the communication line.

In the above embodiment, when the abnormality of the charging plug 54 is present, the provider is allowed to replace the cable unit 100. However, when the abnormality of the charging plug 54 is present, the user as well as the provider may be allowed to replace the charging plug 54. In such a case, the user who is to replace the cable unit 100 may be authenticated. A procedure for replacement may be displayed by the panel 55.

### Summarization

A charger 53 configured to charge a battery 62 for a vehicle 2 includes a plug-locking mechanism 120, a current-voltage controller 152, a detector 153, and a report controller 156. The plug-locking mechanism 120 is configured to lock a charging plug 54 to be plugged into the vehicle 2. The current-voltage controller 152 is configured to apply a test current and a test voltage to the charging plug 54. The detector 153 is configured to detect abnormality of the charging plug 54 based on a condition of the charging plug 54 subjected to the test current and the test voltage that are applied. The report controller 156 is configured to report whether the abnormality is detected by the detector 153.

In this way, it is possible to detect whether the abnormality of the charging plug 54 is present whenever a user uses the charger 53. Thus, a user who has caused the abnormality of the charging plug 54 is easily identified using the charger 53.

The report controller 156 is configured to report whether the abnormality is detected by the detector 153 to the user who uses the charger 53 and the provider who provides the charger 53.

In this way, both the user and the provider are able to be aware that the abnormality of the charging plug 54 has occurred. Accordingly, for example, the provider is able to replace the charging plug 54 promptly. The user, who is aware that the user has caused the abnormality of the charging plug 54, is able to, for example, pay for the replacement.

The charger 53 is able to accept reservations from multiple users, and the report controller 156 is configured to, when the detector 153 detects abnormality, report the abnormality to users having a reservation for using the charger 53.

In this way, since the charger 53 is unavailable for charging the battery 62 because of the abnormality that has occurred, a user having a reservation does not go to a location where the charger 53 is installed and does not waste the effort and time.

The report controller 156 is configured to prompt the user to return the charging plug 54 to a predetermined position when the user finishes charging the vehicle 2.

In this way, since the user returns the charging plug 54 to the original position (holder 142), it is possible to reduce the possibility of being unable to diagnose abnormality because the charging plug 54 is unreturned to the original position.

The current-voltage controller 152 is configured to apply a test current and a test voltage while the charging plug 54 is returned to the predetermined position and is locked by the plug-locking mechanism 120 after the user who uses the charger 53 finishes charging the vehicle 2.

In this way, unplugging the charging plug 54 is prevented during a diagnosis of abnormality. The next user who is unaware that abnormality of the charging plug 54 has occurred may be stopped from charging the battery 62 in the vehicle 2 using the charging plug 54 suffering the abnormality.

A charger 53 configured to charge a battery 62 for a vehicle 2 includes a cable unit 100, a plug-locking mechanism 120, a connector-locking mechanism 130, a current-voltage controller 152, a detector 153, and a report controller 156.

The cable unit 100 includes a charging plug 54, a cable-side connector 101, and a charging cable 102. The charging plug 54 is able to be plugged into the vehicle 2. The cable-side connector 101 is able to be coupled to a main body 110 of the charger 53. The charging cable 102 is coupled to the charging plug 54 on a first end and is coupled to the cable-side connector 101 on a second end. The plug-locking mechanism 120 is configured to lock the charging plug 54. The connector-locking mechanism 130 is configured to lock the cable-side connector 101. The current-voltage controller 152 is configured to apply a test current and a test voltage to the charging plug 54. The detector 153 is configured to detect abnormality of the charging plug 54 based on a condition of the charging plug 54 subjected to the test current and the test voltage that are applied. The report controller 156 is configured to report whether the abnormality is detected by the detector 153.

In this way, while the charger 53 is used by many unspecified users, no person other than the provider is allowed to remove the cable unit 100 from the main body 110 when the charging plug 54 in the charger 53 suffers abnormality. In this way, the provider is allowed to easily replace the cable unit 100 suffering abnormality. In addition, unspecified users or other people are prevented from stealing the cable unit 100.

The charger 53 includes an authenticator 151 configured to authenticate a provider who provides the charger 53, and the connector-locking mechanism 130 is configured to unlock the cable-side connector 101 in response to the provider being authenticated by the authenticator 151.

In this way, no person other than the provider is allowed to remove the cable-side connector 101 from the main body 110. Thus, the provider is allowed to easily replace the cable unit 100 while preventing the cable unit 100 from being stolen.

The connector-locking mechanism 130 is configured to unlock the cable-side connector 101 in response to the provider being authenticated by the authenticator 151 after the detector 153 detects the abnormality.

In this way, the cable-side connector 101 is prevented from being removed needlessly when no abnormality of the charging plug 54 is found.

The authenticator 151 is configured to authenticate a user who is to use the charger 53, and the plug-locking mechanism 120 is configured to unlock the charging plug 54 in response to the user being authenticated or in response to the provider being authenticated.

No person other than the provider is allowed to remove the cable-side connector 101, but unless the user as well as the provider is allowed to remove the charging plug 54, the user is unable to use the charger 53. Accordingly, the user and the provider are allowed to unlock the charging plug 54, and thereby the user is able to easily use the charger 53.

The report controller 156 is configured to prompt the user who uses the charger 53 to return the charging plug 54 to a predetermined position when the user finishes charging the vehicle 2, and the current-voltage controller 152 is configured to apply the test current and the test voltage after the charging plug 54 is returned to the predetermined position.

In this way, unplugging the charging plug 54 is prevented during a diagnosis of abnormality. The next user who is unaware that abnormality of the charging plug 54 has occurred may be stopped from charging the battery 62 in the vehicle 2 using the charging plug 54 suffering the abnormality.

According to the disclosure, a charging plug easily replaceable by a provider is provided.

The charger controller 141 illustrated in FIG. 6 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the charger controller 141 including the authenticator 151, the current-voltage controller 152, the detector 153, the plug-locking controller 154, the connector-locking controller 155, and the report controller 156. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 6.

1. A charger configured to charge a battery for a vehicle, the charger comprising:
a cable unit comprising a charging plug configured to be plugged into the vehicle, a connector configured to be coupled to a main body of the charger, and a charging cable coupled to the charging plug on a first end and coupled to the connector on a second end;
a plug-locking mechanism configured to lock the charging plug;
a connector-locking mechanism configured to lock the connector;
a current-voltage controller configured to apply a test current and a test voltage to the charging plug;
a detector configured to detect abnormality of the charging plug based on a condition of the charging plug when the test current and the test voltage are applied to the charging plug;
a report controller configured to report whether the abnormality is detected by the detector; and
an authenticator configured to authenticate a provider who provides the charger,
wherein the connector-locking mechanism is configured to unlock the connector in response to the provider being authenticated by the authenticator.

2. The charger according to claim 1,
wherein the connector-locking mechanism is configured to unlock the connector in response to the provider being authenticated by the authenticator after the detector detects the abnormality.

3. The charger according to claim 1,
wherein the authenticator is configured to authenticate a user who is to use the charger, and
the plug-locking mechanism is configured to unlock the charging plug in response to the user being authenticated or in response to the provider being authenticated.

4. The charger according to claim 1,
wherein the report controller is configured to prompt the user who uses the charger to return the charging plug to a predetermined position when the user finishes charging the vehicle, and
the current-voltage controller is configured to apply the test current and the test voltage after the charging plug is returned to the predetermined position.

5. A charger configured to charge a battery for a vehicle, the charger comprising:
a cable unit comprising a charging plug configured to be plugged into the vehicle, a connector configured to be coupled to a main body of the charger, and a charging cable coupled to the charging plug on a first end and coupled to the connector on a second end;
a plug-locking mechanism configured to lock the charging plug;
a connector-locking mechanism configured to lock the connector; and
circuitry configured to
apply a test current and a test voltage to the charging plug;
detect abnormality of the charging plug based on a condition of the charging plug when the test current and the test voltage that are applied to the charging plug;
report whether the abnormality is detected; and
authenticate a provider who provides the charger,
wherein the connector-locking mechanism is configured to unlock the connector in response to the provider being authenticated by the authenticator.
